(19) United States
(12) Patent Application Publication
(10) Pub. No.: US 2019/0107895 A1
(43) Pub. Date: Apr. 11, 2019

(54) WIRELESS DIAL UNIVERSAL REMOTE CONTROL DEVICE

(71) Applicant: Daniel James STEINMAN, Toronto (CA)

(72) Inventor: Daniel James STEINMAN, Toronto (CA)

(21) Appl. No.: 16/156,645

(22) Filed: Oct. 10, 2018

Related U.S. Application Data
(60) Provisional application No. 62/570,699, filed on Oct. 11, 2017.

(51) Int. Cl. G06F 3/01; G08C 17/02; G06F 3/16

(52) U.S. Cl. CPC G06F 3/017; G08C 17/02; G08C 2201/92; G06F 3/165; G06F 3/162

(57) ABSTRACT

The present invention is a wireless dial universal remote control device that is a versatile new kind of universal remote that is simple to use and is more fluid way of controlling many devices connected to the home. It is best suited for audio-video equipment, which can make use of the excellent fine-tuning and multi-device gesture capabilities.

### RELATED APPLICATION

The present invention claims the priority date of the provisional patent application No. 62/570,699 filed on Oct. 11, 2017.

### FIELD OF THE INVENTION

The present invention relates generally to computer peripherals, and especially to audio/video remote controls.

### BACKGROUND OF THE INVENTION

One of the commonly used electronic controllers is the Hand-held Infrared Remote Control that is typically supplied with televisions and CD/Blu-ray players. Hand-held infrared remote controls have the following problems:
Require a “line of sight” with the equipment. The remote must be pointed directly at the equipment and it does not operate through walls/floors or around corners.
Have limited fine-tuning ability since all functions are operated with discrete buttons (e.g., Volume Up, Volume Down, Seek Left, Seek Right) which limit how quickly repeated presses can be performed (e.g. how fast to change the volume).
One-way communication. IR remotes contain infrared transmitters that send actions to the equipment, but typically do not have infrared receivers to receive information notifications from the equipment that is being operated. For example, pressing the “volume up” button will not guarantee the volume actually was changed.

A more advanced type of remote control that can combine features from separate electronic devices into a single remote control device is a Universal Remote Control. Universal Remote Controls have all the same limitations listed above, but also, because they combine features from multiple infrared devices, new synchronization problems occur when the infrared light misses it's target. For example, the IR signal to switch the stereo receiver input to “CD” maybe not be received, but the remote control assumes the signal was received and goes into CD mode.

### SUMMARY OF THE INVENTION

The present invention is a wireless control dial that connects to the wireless home network, or directly to a mobile device with Bluetooth connectivity. The user installs software (mobile app or desktop computer software) to configure the devices and software they wish to operate using the control dial. The network is scanned for compatible devices and network connections are established between the devices, and network protocols are used to exchange messages between the devices and maintain information about the states of each device.

The presently disclosed wireless control dial resolves all the issues of IR controllers:
Wi-Fi and Bluetooth wireless operation eliminates line-of-sight problems associated with infrared remotes. The device can control the equipment anywhere within the range of the wireless network.
Knobs or dials provide fine-tuning ability to remotely operate electronics.
The wireless control dial can perform bi-directional communication with the devices it controls. Example: the stereo volume or navigation direction can be communicated to dial to turn on lights, thereby indicating the new volume level.
The wireless control dial establishes network connection to the devices; it operates which resolves synchronization errors that occur with typical universal remote controls.

The present invention is a wireless dial universal remote control device which can connect to a plurality of devices and control them, the volume knob and control dial of the present invention comprising of an oval-shaped housing having a distal end, a proximal end, a top surface, a bottom surface and peripheral walls, a rotatable knob at the distal end having an embedded rotary encoder with a built-in push-button switch at it's center, wherein the rotatable knob configured to receive a plurality of gesture operations from a user; a second push-button switch at the proximal end configured to receive a plurality of gesture operations from the user.

A network connection is established between the volume knob and control dial and at least one device and a state detection module in the present invention detects a state-operation of the devices and exchanges and maintains a state-information between the devices.

A gesture detection module in the present invention interprets combination of the gesture operations from the rotatable knob, the built-in push-button switch and the second push-button switch and an action module in the present invention functions based on the gesture detection module.

A control module in the present invention configured to manage the state detection module, the gesture detection module and the action module in the present invention.

Devices, equipment, and software that can be controlled by the dial include but is not limited to: Audio devices (stereo amplifiers, preamplifiers, home theater receivers, wireless speakers); Media playback devices (cd players, Blu-ray players, digital media players, smart TV applications; Smart Light Dimmers (Wi-Fi-enabled lights in the home); Computers (operations on the dial can perform keypresses on computers); Software (utilizing the control dial network protocol, new operations can program).

By utilizing gesture operation of the dial (combinations of button presses and turning the knob), the user can control more than one device simultaneously. By maintaining operation state of the devices (e.g., detecting the Play or Pause state of a DVD Player) the dial can automatically switch the functions that will be operated between different devices.

Example 1: while a stereo receiver is switched to “FM Tuner”, the dial can adjust the radio station. But while the stereo receiver is switched to “DVD Player”, the dial can activate Fast Forward or Rewind operations of the DVD player.

Example 2: while a DVD is playing a video, turning the knob changes the volume of the stereo. And while not playing a DVD movie, turning the knob operates the DVD graphical user-interface (navigates up and down).

Gestures can include combinations of knob and button presses to greatly expand the potential number of functions and number of devices that can be controlled with the dial.

Stereo receivers have knobs mounted on the front panel of the devices, they cannot be moved at will, and limit their use to when the user is within physical reach of the stereo. Remote controls with buttons are not suitable for fine-tuning operation.

Universal remote controls do not know the state of the devices they control, lose synchronization, and cannot utilize gesture operations to switch devices and modes.

A wireless knob provides an extra control for device with fixed knobs and dials. By being wireless, the knob can be placed in a more suitable location. Knobs and dials are superior to discrete buttons for fine-tuning operations. A wireless dial universal remote control device with network connections to the devices can maintain state information about the devices, so as not to lose synchronization, and using a combination of gestures can operate and switch between more than one device and one mode at a time.

The present invention improves usability of electronic devices at home and it is a better replacement for universal remote controls. The present invention requires a combination of hardware and a unique type of human-interface knowledge and gesture actions to solve the problems with the IR remotes. It has the following advantages: a knob or dial with wireless connectivity; one or more additional buttons (to enable gesture capabilities); network connections to one or more electronic devices; network protocols to transmit state and operational information between device, and interpretation software to connect to network devices (network stereos, players) and implement gesture operations.

The presently disclosed “wireless a dial universal remote” operates as a new type of remote controller for stereo systems, televisions, and many other types of consumer electronics. A typical stereo receiver has 2 knobs on the front panel, one to change the volume and a separate knob for tuning the AM/FM radio channel, or other selection and tuning features. The wireless control dial can replace both knobs and allow the user to place the knob anywhere in the wireless (Wi-Fi or Bluetooth) range of the home or office. The wireless control dial also have advantages over infrared button remotes, such as not requiring “line of sight” with the equipment, extended range, and superior fine-tuning of the volume, digital media navigation, and other remote operations. The dial also supports gesture-operations, by combining knob and button actions, different actions can be performed or different devices can be controlled.

Multiple wireless remotes can be used simultaneously allowing every room in a home to have a remote, or different remotes paired to different devices, and indication lights on the remotes can be synchronized using centralized network software. When two or more remotes are operating the same device, control software rules can determine how to combine operations (e.g. determine what happens when two dials are turning the volume up simultaneously) or yield control to one of the devices (e.g. let one dial take total control temporarily).

### BRIEF DESCRIPTION OF THE DRAWINGS

Embodiments herein will hereinafter be described in conjunction with the appended drawings provided to illustrate and not to limit the scope of the claims, wherein like designations denote like elements, and in which:

FIG. 1 shows a perspective view of the present invention;

FIG. 2 shows a top view of the present invention;

FIG. 3 shows a side view of the present invention;

FIG. 4 shows a perspective view of the present invention;

FIG. 5 shows a perspective view of the present invention with the electronic components inside the housing;

FIG. 6 shows a schematic diagram of the present invention;

FIG. 7 shows gestures and functions of the present invention in KODI software;

FIG. 8 shows gestures and functions of the present invention in KODI software;

FIG. 9 shows gestures and functions of the present invention in wireless speaker (SONOS amplifier);

FIG. 10 shows gestures and functions of the present invention in iTunes software;

FIG. 11 shows gestures and functions of the present invention in stereo receiver (Denon);

FIG. 12 shows gestures and functions of the present invention in scroll wheel;

FIG. 13 shows gestures and functions of the present invention in system audio;

FIG. 14 shows gestures and functions of the present invention in Bluetooth speaker;

FIG. 15 shows a flow chart represents the basic logic algorithm for the gestures to control both a digital media player (Kodi) and a stereo receiver (Denon) simultaneously, and

FIG. 16 shows a flow chart represents the basic logic algorithm for the gestures to control both a digital media player (Kodi) and a stereo receiver (Denon) simultaneously.

### DETAILED DESCRIPTION OF PREFERRED EMBODIMENTS

The figures are not intended to be exhaustive or to limit the present invention to the precise form disclosed. It should be understood that the invention can be practiced with modification and alteration, and that the disclosed technology be limited only by the claims and equivalents thereof.

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

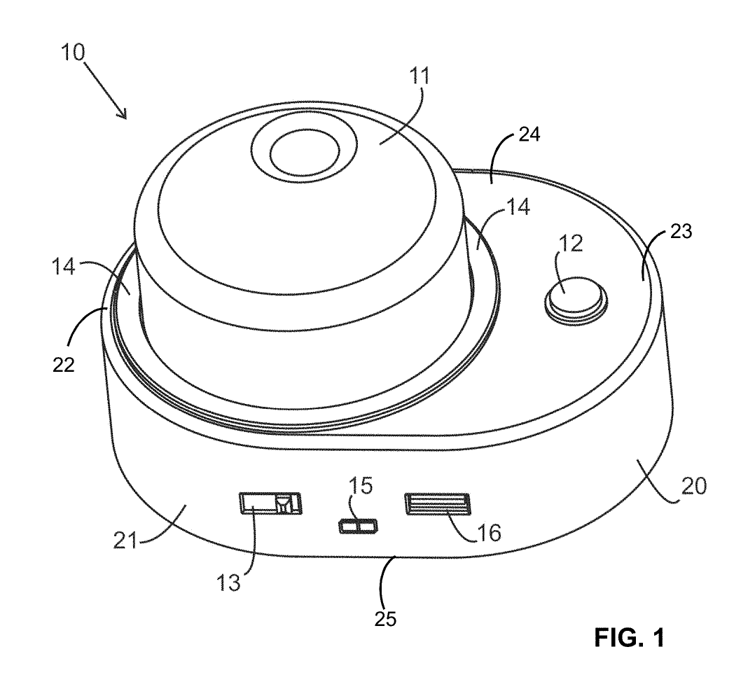

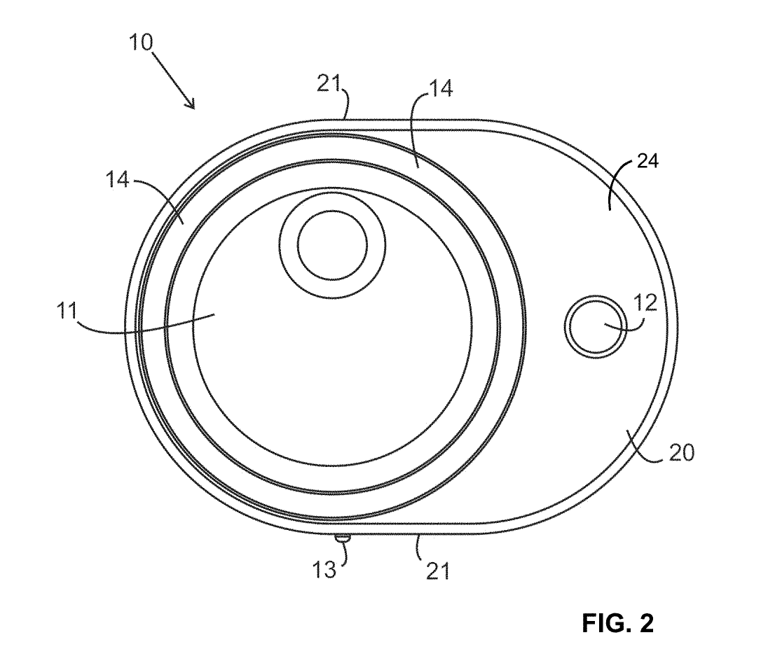

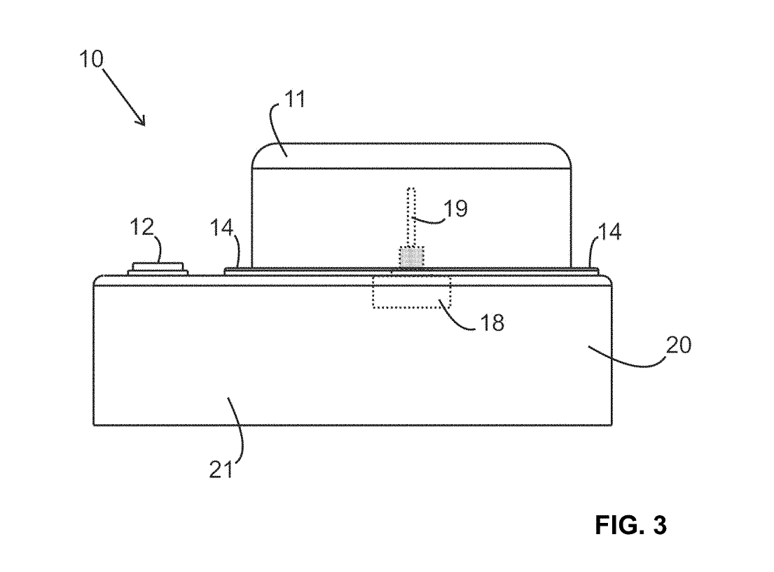

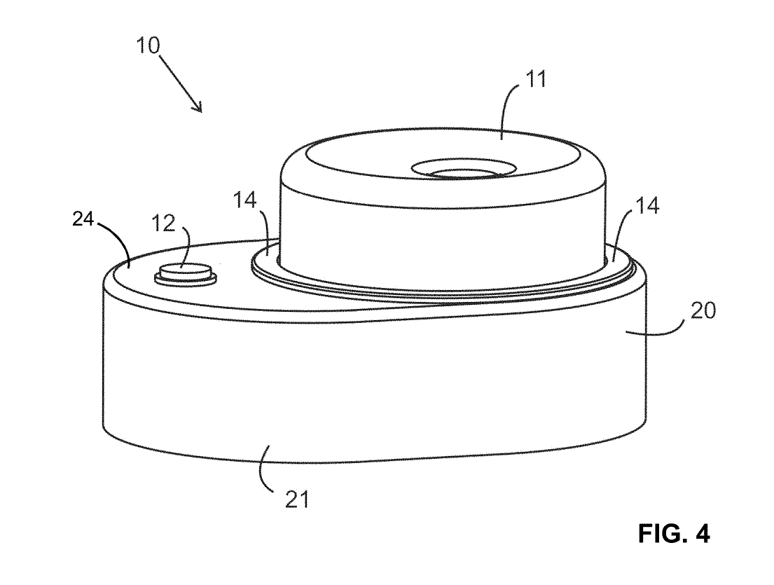

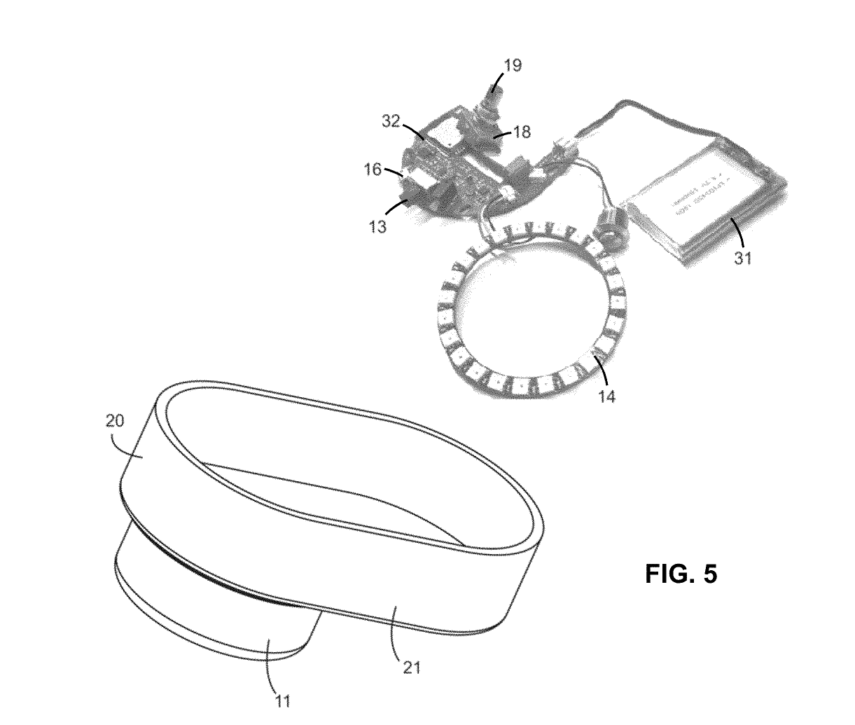

As shown in FIGS. 1-5, the present invention 10 comprises of a knob 11 which has an embedded rotary encoder 18 with built-in push-button switch 19 at the centre; a push-button switch 12; a power switch 13; Multi-color indication lights 14, which are fixed in a circle, surrounding the knob 11; a power and battery indication lights 15; a USB port 16; a Wi-Fi radio transmitter; a Bluetooth radio transmitter; a microcontroller; a Lithium-Ion battery 31; a battery charging electronics, and electronic components 32 such as resistors, capacitors, diodes, and mosfets inside a housing 20.

Again as shown in FIGS. 1-5, the volume knob and control dial 10 of the present invention comprising of an oval-shaped housing 20 having a distal end 22, a proximal end 23, a top surface 24, a bottom surface 25 and peripheral walls 21, a rotatable knob 11 at the distal end 22 having an embedded rotary encoder 18 with a built-in push-button switch 19 at it's center, wherein the rotatable knob 11 configured to receive a plurality of gesture operations from a user; a second push-button switch 12 at the proximal end 23 configured to receive a plurality of gesture operations from the user.

The rotary encoder 18 and the knob 11 are mounted vertically. The knob 11 is made out of solid metal or any other material to provide enough mass and momentum to spin freely and smoothly about the encoder 18. The housing 20 with oval or egg shape contains all the electronic components. Any suitable material can be used to make different parts of this device.

The multi-color indication lights 14 (such as multi-color LEDs) are mounted on the top of the housing 20 in circle surrounding the knob 11 and provide notifications from an equipment being controlled. The number of LEDs (or other types of lights) that turn on and their color change are based on the state of the equipment being controlled, configuration options, software rules and gesture modes activated.

The USB port 16, power indication lights 15 (bi-color LED), and power switch 13 are mounted on a side wall 21 of the housing 20. Inside the housing 20, there are a microcontroller, Wi-Fi antenna, Bluetooth antenna, lithium-ion battery, and all required electronic components to connect and power the devices appropriately.

Firmware code is written to provide a network protocol to interface the present invention 10 with other network devices on a Wi-Fi home network, or directly with a mobile device using Bluetooth.

The protocol in the present invention is bi-directional. Once the present invention 10 is connected to another network device, the protocol transfers state and configuration data to determine modes, gesture, and devices to be controlled by the present invention 10.

For operation of the present invention, a user installs the present invention software and uses a GUI to scan the Wi-Fi network for supported devices, or manually specifies the network information, and selects the devices to be controlled by the present invention 10, and optionally saves this information for later use and faster start-up times.

After configuration is complete, initial state data is exchanged, and the dial's indication lights shine with appropriate colors to inform the user about the state of the devices. Example: Flashing green means successful connection, flashing red means error.

The wireless dial universal remote control device has a circular multi-color indication light surrounding the rotatable knob at the top, wherein the circular multi-color indication light provides a plurality of notifications and the state-information from the device being controlled. The circular multi-color indication light has a plurality of LEDs on the circular multi-color indication light, wherein said LEDs turn on and their color change are based on the state-information and state-operation of the device being controlled.

Once a successful connection is established, the present invention 10 enters operational mode. Turning the knob 11, and pressing rotary encoder button, or secondary button 12, transmits the information about an action to the network device(s) and is interpreted and performs the corresponding desired action on the connected device.

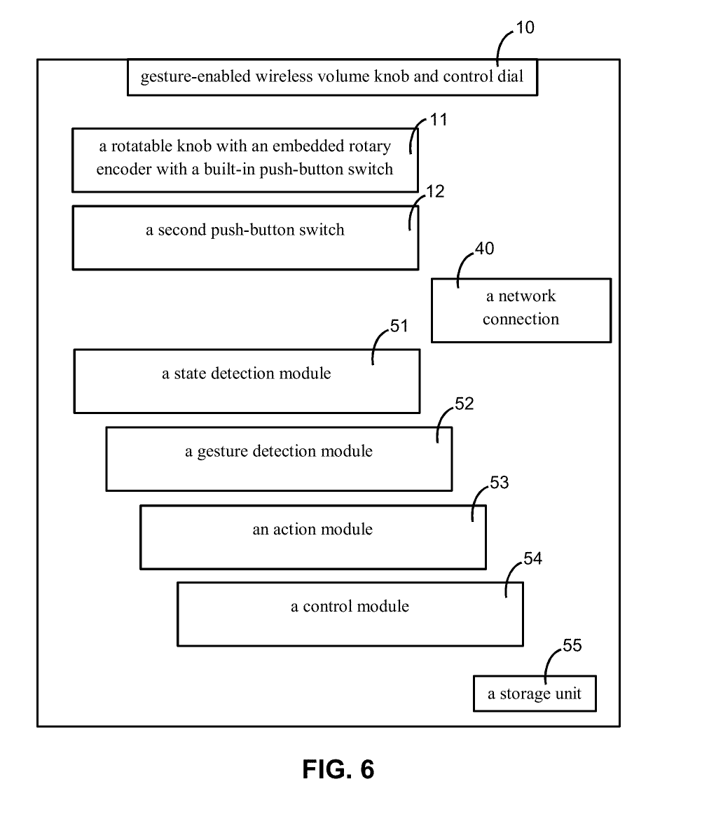

FIG. 6 shows a schematic diagram of the present invention. The present invention is a wireless dial universal remote control device 10 which can connect to a plurality of devices and control them. A network connection 40 is established between the volume knob and control dial 10 and at least one device and a state detection module 51 in the present invention detects a state-operation of the devices and exchanges and maintains a state-information between the devices.

Again as shown in FIG. 6, a gesture detection module 52 in the present invention interprets combination of the gesture operations from the rotatable knob 11, the built-in push-button switch 19 and the second push-button switch 12 and an action module 53 in the present invention functions based on the gesture detection module 52.

Again as shown in FIG. 6, a control module 54 in the present invention configured to manage the state detection module 51, the gesture detection module 52 and the action module 53 in the present invention.

Again as shown in FIG. 6, the wireless dial universal remote control device of the present invention further has a storage unit 55 coupled to the control module 54, the storage unit 55 configured to store the state-operation and the state-information.

The wireless dial universal remote control device can be connected and control a plurality of devices. The devices are selected from the groups consisting of an audio device, a stereo amplifier, a preamplifier, a home theater receiver, a wireless speaker, a media playback devices, a cd player, a Blu-ray player, a digital media player, a smart TV application, a smart light dimmer, a computer, and a computer software.

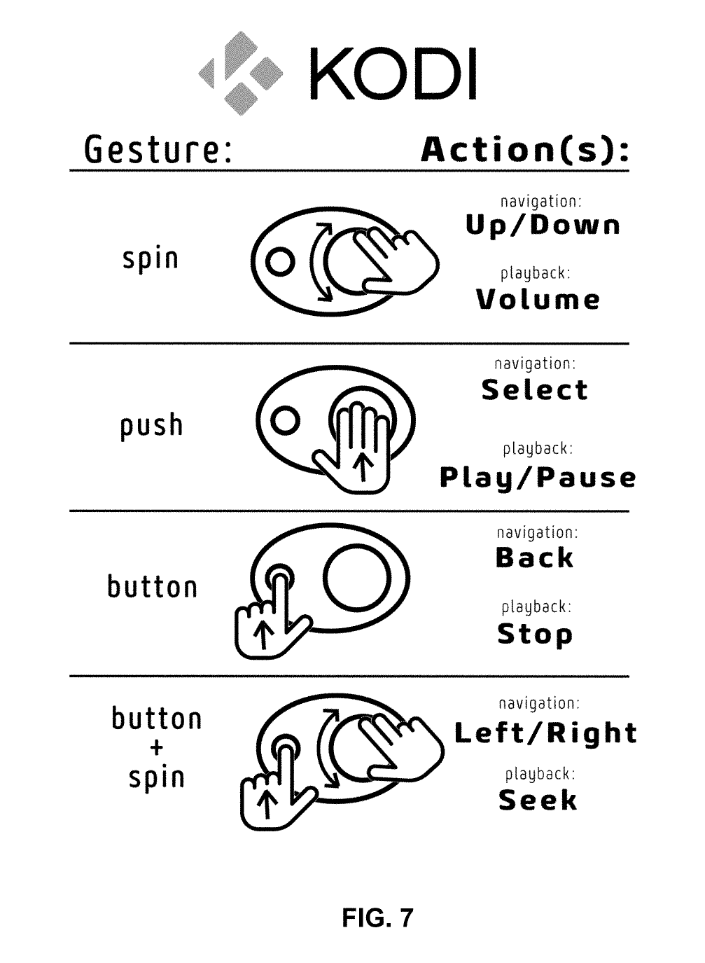

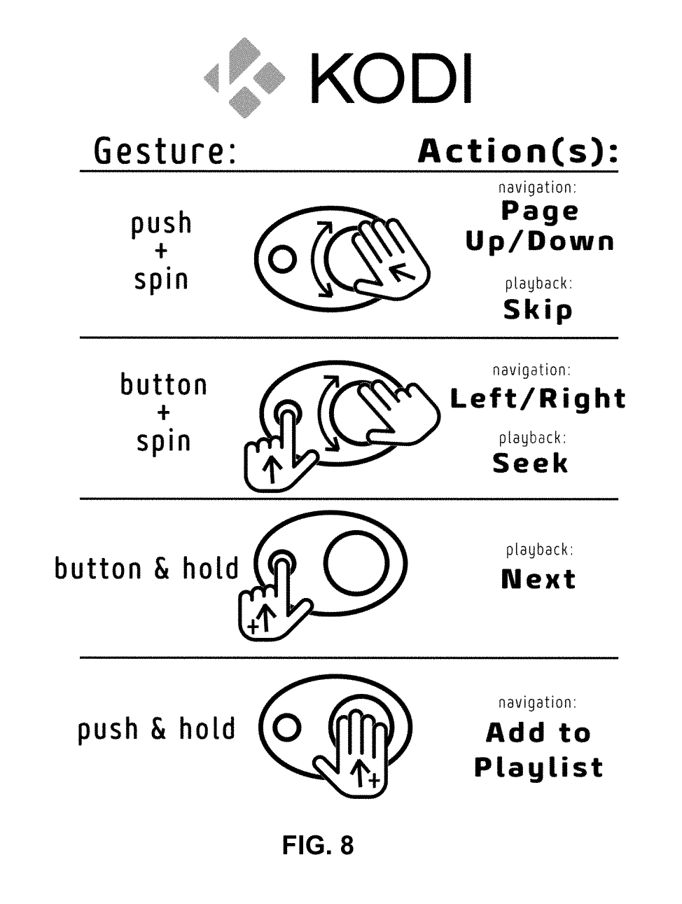

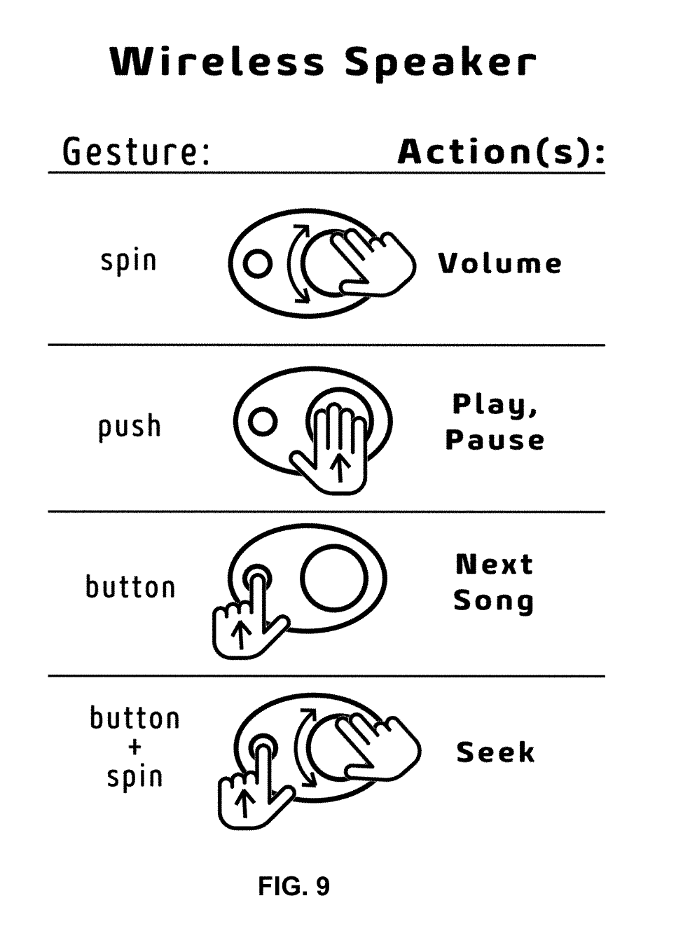

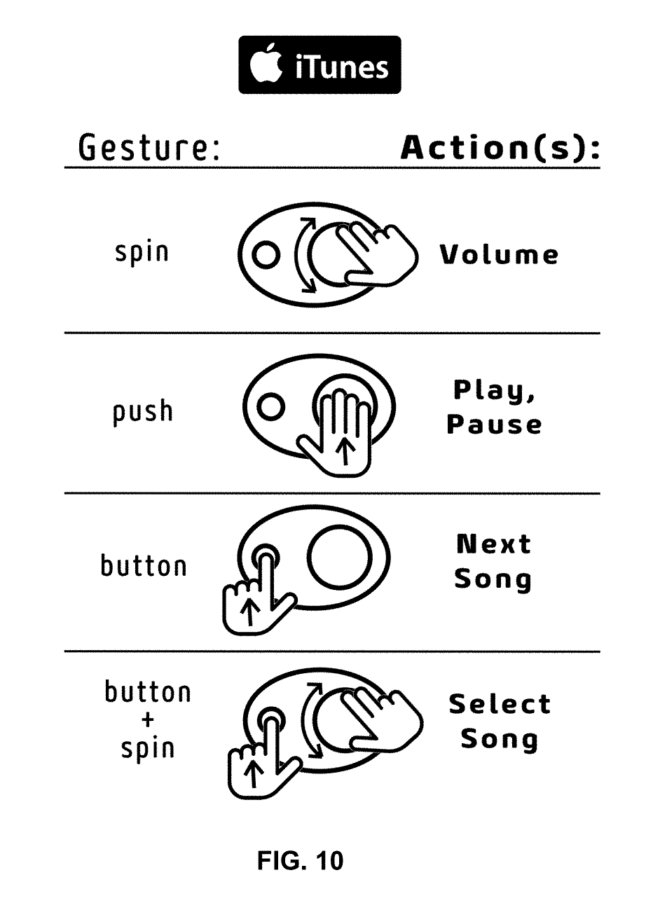

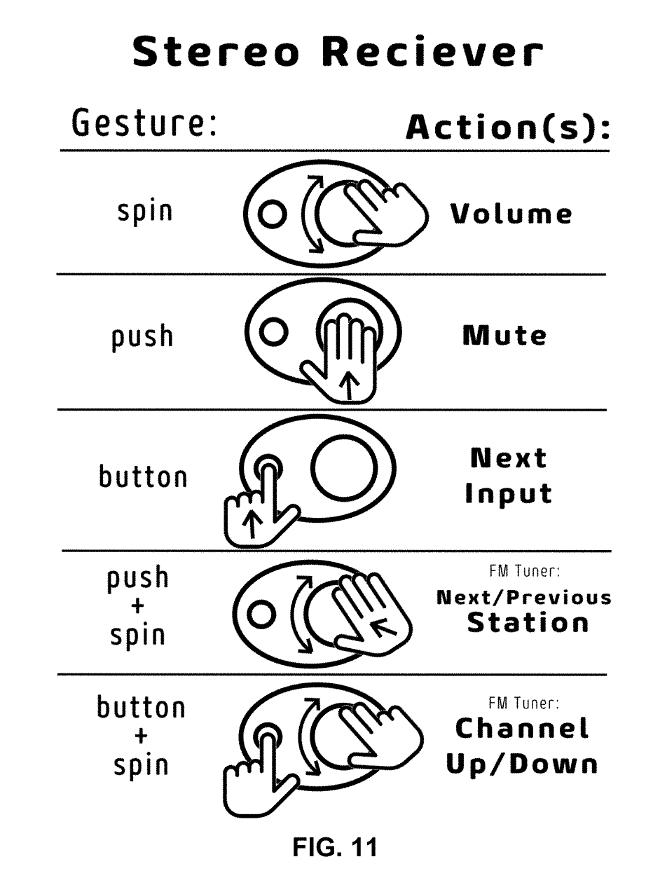

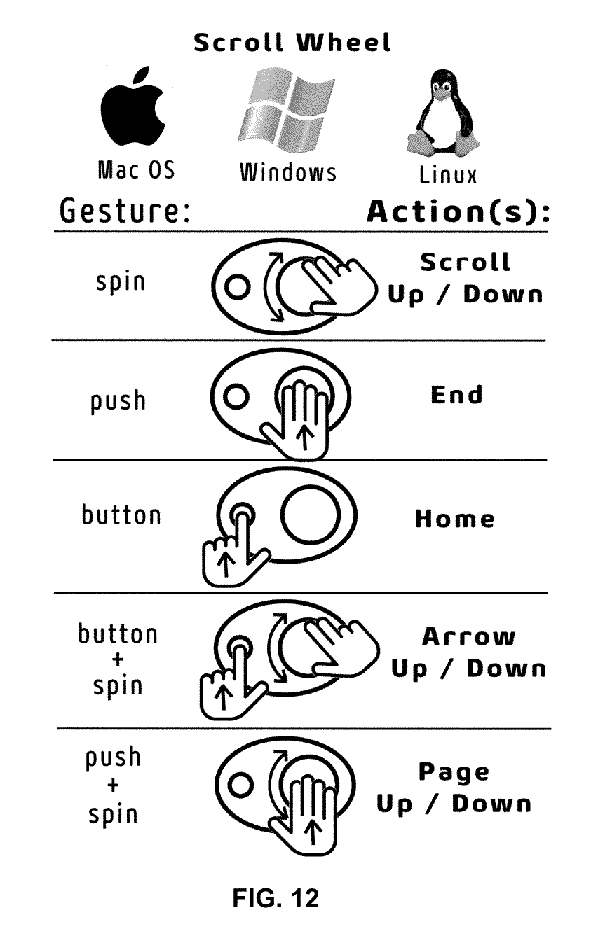

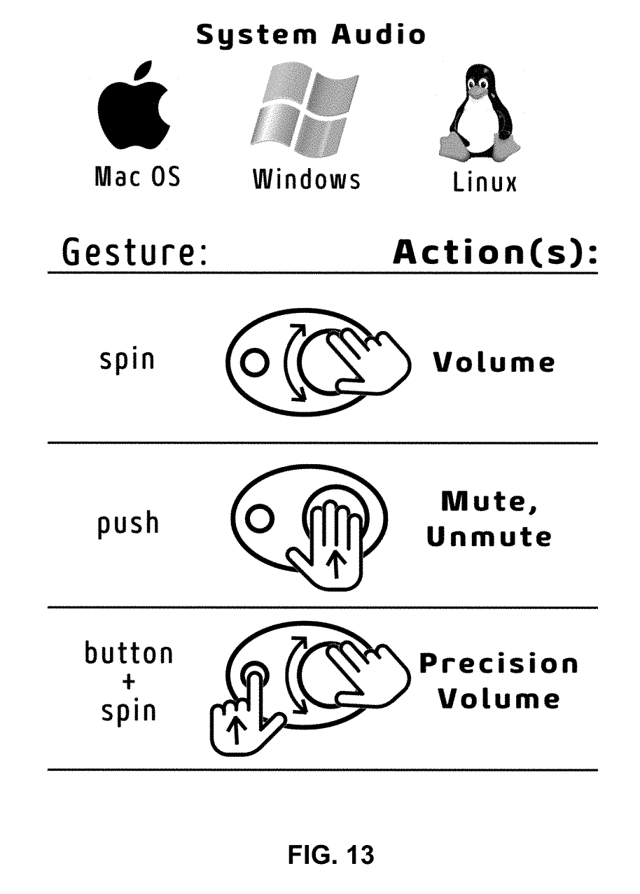

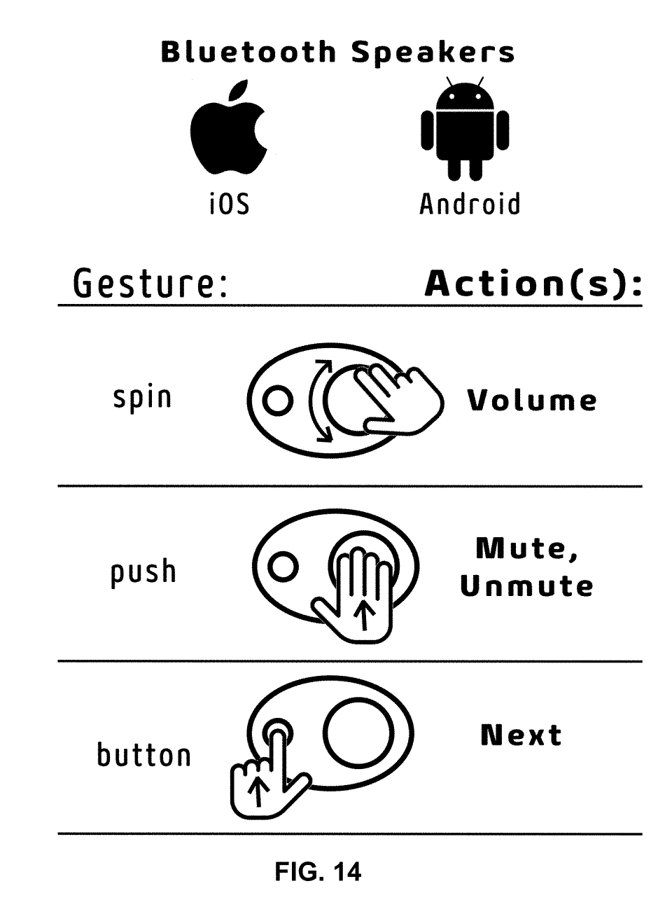

FIGS. 7-14 show different gestures and functions in the present invention in different devices and platforms.

Example: If the present invention 10 is configured to control a stereo receiver, while turning the knob 11 clockwise; the present invention 10 uses the network protocol to transmit a “spin right” event to the stereo receiver (or software which controls the receiver) and interprets the event and then increases the volume by 1 decibel. Similarly turning knob 11 counter-clockwise sends “spin left” event, which decreases the volume by 1 decibel.

Pressing and releasing the knob's primary button 11, or secondary button 12, transmits events in a similar way. Pressing the rotary button transmits a “push knob” event and pressing the secondary buttons 12 transmit a “press button” event. Releasing the rotary button sends “release knob” event and releasing the secondary button 12 transmits a “release button” event. The Push, Press and Release events, and the Spin Right, and Spin Left events, are transmitted independently and can be interpreted simultaneously (this is very important and unique for the present invention).

These spin, push, and release events can be captured and processed to enable gestures to be written to activate and de-activate different modes or switch devices according to rules and configuration options defined in software rules as shown in FIGS. 7-14.

Rules can be encoded in the gesture detection module that enables different device actions to be performed when a specific combination of buttons are pressed and released and/or when the knob is turned. Some examples for different actions and gesture in the present invention are presented:
Spin Right event+no buttons pressed=(Stereo) Volume Up action
Push Primary event+Spin Right event=(DVD) Fast-Forward action
Push Secondary event+Spin Right event=(Stereo) Increase Bass Boost action
Push Primary event+Push Secondary event=(Stereo) Power Off

Rules can also be used to transmit information back to the present invention.
(Stereo) Volume Up event=Control Dial lights accordingly, at 50% volume half of the LED's will turn on,
(DVD Player) Pause event=All lights shine yellow.

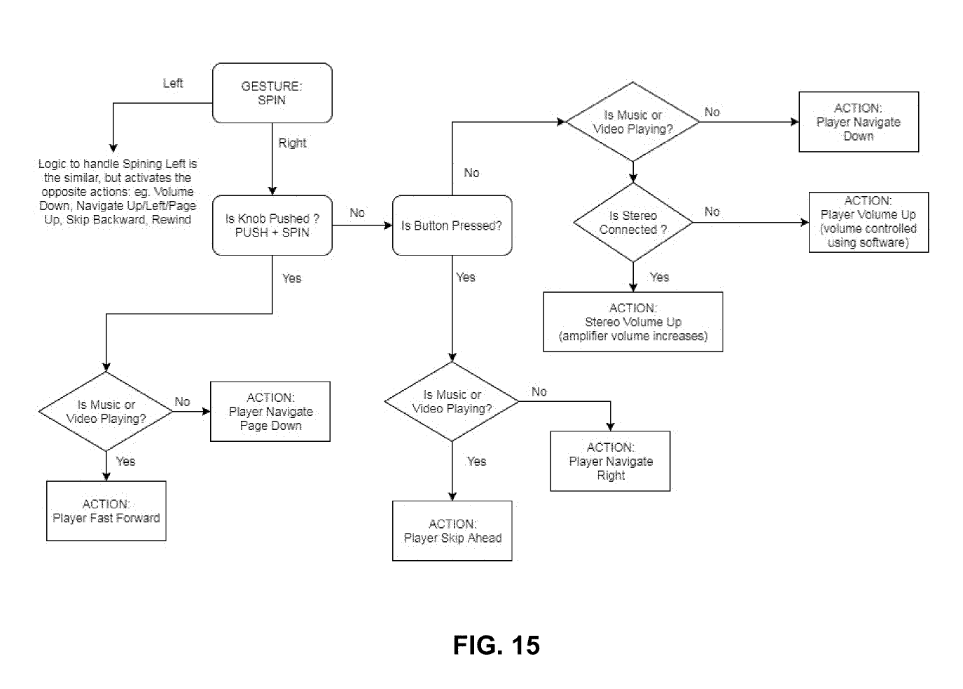

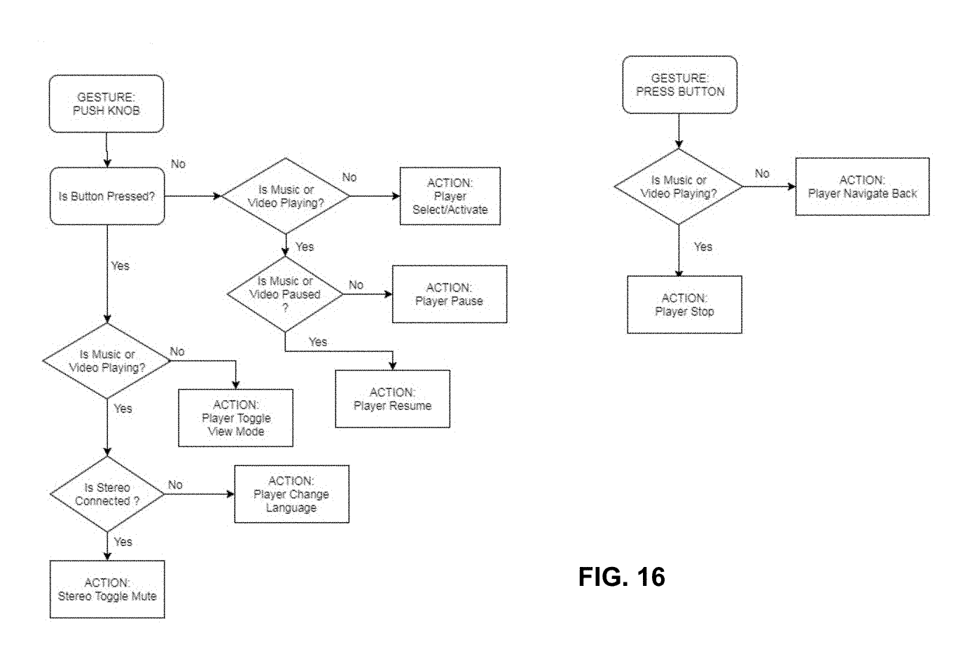

As shown in FIGS. 15-16, the flow chart represents the basic logic algorithm for the gestures to control both a digital media player (Kodi) AND a stereo receiver (Denon) simultaneously. Using this logic a knob with one button can perform a total of 22 end result actions. The actual implementation of this is a bit more complicated because the PRESS and RELEASE actions of the knob and button are handled as well as timestamps and delays, whereas the flow chart shows them combined into single actions.

In one embodiment of the present invention, the indication lights and buttons are optional and may be omitted from the design of the present invention. Other functions of the present invention with the new embodiment would still be the same as the original design.

In another embodiment of the present invention, additional buttons could enable a high number of potential gesture options. Additional types of components added to the present invention could further expand its capabilities. Example of additional buttons: joystick, accelerometer, gyroscope, microphone.

In another embodiment of the present invention, the wireless dial universal remote control device can be used to control a smart light dimmer system.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

With respect to the above description, it is to be realized that the optimum relationships for the parts of the invention in regard to size, shape, form, materials, function and manner of operation, assembly and use are deemed readily apparent and obvious to those skilled in the art, and all equivalent relationships to those illustrated in the drawings and described in the specification are intended to be encompassed by the present invention.

What is claimed is:

1) A wireless dial universal remote control device to connect to and control a plurality of devices, said volume knob and control dial comprising:
a) an oval-shaped housing having a distal end, a proximal end, a top surface, a bottom surface and peripheral walls;
b) a rotatable knob at the distal end having an embedded rotary encoder with a built-in push-button switch at it's center, wherein said rotatable knob configured to receive a plurality of gesture operations from a user;
c) a second push-button switch at the proximal end configured to receive a plurality of gesture operations from the user;
d) a network connection is established between the volume knob and control dial and at least one device;
e) a state detection module to detect a state-operation of the devices and to exchange and maintain a state-information between the devices;
f) a gesture detection module to interpret combination of the gesture operations from the rotatable knob, the built-in push-button switch and the second push-button switch;
g) an action module to function based on the gesture detection module, and
h) a control module configured to manage the state detection module, the gesture detection module and the action module.

2) The wireless dial universal remote control device of the claim 1, wherein said devices being selected from the groups consisting of an audio device, a stereo amplifier, a preamplifier, a home theater receiver, a wireless speaker, a media playback devices, a cd player, a Blu-ray player, a digital media player, a smart TV application, a smart light dimmer, a computer, and a computer software.

3) The wireless dial universal remote control device of the claim 1, further has a circular multi-color indication light surrounding the rotatable knob at the top, wherein said circular multi-color indication light provides a plurality of notifications and the state-information from the device being controlled.

4) The wireless dial universal remote control device of the claim 2, further has a plurality of LEDs on the circular multi-color indication light, wherein said LEDs turn on and their color change are based on the state-information and state-operation of the device being controlled.

5) The wireless dial universal remote control device of the claim 1, further has a power light and a battery indication light.

6) The wireless dial universal remote control device of the claim 1, further has a USB port at said peripheral walls to connect to a computer for programming or charging a rechargeable battery.

7) The wireless dial universal remote control device of the claim 1, further has a Wi-Fi radio transmitter or a Bluetooth radio transmitter to connect to the devices.

8) The wireless dial universal remote control device of the claim 1, further has a microcontroller to provide firmware system programming and WiFi/BT or Bluetooth antenna.

9) The wireless dial universal remote control device of the claim 1, further has a Lithium-Ion battery, a battery charging station, and a power switch.

10) The wireless dial universal remote control device of the claim 1, wherein said gesture-enabled wireless volume knob and control dial controls a plurality of devices simultaneously and switches the action module between different devices.

11) The wireless dial universal remote control device of the claim 1, wherein a plurality of wireless dial universal remote control devices is connected to the devices.

12) The wireless dial universal remote control device of the claim 1, further has a storage unit coupled to the control module, the storage unit configured to store the state-operation and the state-information.

13) The wireless dial universal remote control device of the claim 1, wherein said rotatable knob is located on the top surface of the oval-shaped housing.

14) The wireless dial universal remote control device of the claim 1, wherein said gesture operations comprises of a push gesture, a press and release event, a spin right event, and a spin left event.
